(19) United States
(12) Patent Application Publication
(10) Pub. No.: US 2008/0287180 A1
(43) Pub. Date: Nov. 20, 2008

(54) GAMING MACHINE COMMUNICATIONS

(75) Inventor: Christer Hutchinson-Kay, Taby (SE)

Correspondence Address: MCANDREWS HELD & MALLOY, LTD, 500 WEST MADISON STREET, SUITE 3400, CHICAGO, IL, 60661, US

(73) Assignee: ACEI AB, Stockholm (SE)

(21) Appl. No.: 12/118,456

(22) Filed: May 9, 2008

(30) Foreign Application Priority Data
May 16, 2007 (AU) 2007902622

(51) Int. Cl. G06F 17/00

(52) U.S. Cl. 463/20; 463/40

(57) ABSTRACT

A gaming machine that provides a game in which a plurality of symbols are selected and presented and if a winning combination occurs in the selected symbols, the gaming machine awards an award, the gaming machine comprising a communication interface for receiving and sending data to a remote device and an alphanumeric keypad and in response to operation of the alphanumeric keypad the gaming machine causes a message to be generated using predictive text input technology, wherein the gaming machine is further arranged to send the generated message to the remote device over the communication interface, and wherein the gaming machine further includes a display that is controlled to display messages generated by and sent by the gaming machine and messages received by the gaming machine.

### CROSS-REFERENCE TO RELATED APPLICATIONS

This application claims priority to Australian Provisional Patent Application No. 2007902622, having an international filing date of May 16, 2007, entitled “Gaming Machine Communications,” which is hereby incorporated by reference herein in its entirety.

### FIELD OF THE INVENTION

The present invention generally relates to gaming machines and methods of communication utilising gaming machines.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

Gaming machines are usually an individual activity, with a player playing a machine with little or no interaction with other people. This may reduce the enjoyment or satisfaction of some players of gaming machines, as they have limited if any ability to engage with others to share in their experience.

One method of providing interaction between players is to provide a tournament game. In a tournament game players may work together or compete against each other to achieve an objective. Usually an award is associated with the objective and may be awarded by one or more of the gaming machines that participated in the tournament. However, the amount of interaction between players is limited to participation in the tournament game.

There remains a need to provide gaming machines and systems that effectively facilitate interaction between players.

### SUMMARY OF THE INVENTION

According to a first aspect, the invention broadly resides in a gaming machine that provides a game in which a plurality of symbols are selected and presented and if a winning combination occurs in the selected symbols, the gaming machine awards an award, the gaming machine including a communication interface for receiving and sending data to a remote device and an alphanumeric keypad and in response to operation of the alphanumeric keypad the gaming machine causes a message to be generated using predictive text input technology, wherein the gaming machine is further arranged to send the generated message to the remote device over the communication interface, and wherein the gaming machine further includes a display that is controlled to display messages generated by and sent by the gaming machine and messages received by the gaming machine.

In one embodiment, the gaming machine further comprises a player tracking module or other card interface and the alphanumeric keypad may be implemented as physical buttons provided on the player tracking module or card interface. The player tracking module or card interface may include a display, wherein the display on which the message messages are displayed is the display of the player tracking module or card interface. The card interface may be a credit card reader.

In another embodiment, the display on which the messages are displayed is also controlled to display representations of the game provided by the gaming machine and the alphanumeric keypad is implemented using images and a touch screen provided as part of the same display.

According to a second aspect, the invention broadly resides in a gaming machine that provides a game in which a plurality of symbols are selected and presented and if a winning combination occurs in the selected symbols, the gaming machine awards an award, the gaming machine including a communication interface for receiving and sending data to a remote device and a touch screen over a display, wherein the display is controlled to present an alphanumeric keypad and in response to operation of the touch screen over the alphanumeric keypad the gaming machine causes a message to be generated using predictive text input technology, wherein the gaming machine is further arranged to send the generated message to the remote device over the communication interface, and wherein the gaming machine further includes a display that is controlled to display the sent message and display messages received by the gaming machine from a remote device.

The display may be controlled to display the alphanumeric keypad only after detecting selection of an icon previously displayed on the display.

The display may be controlled to display the alphanumeric keypad over a game screen that presents the selected symbols, wherein the display of the alphanumeric keypad over the game screen allows all selected symbols to remain clearly visible to the player. The alphanumeric keypad may be displayed transparently or semi-transparently so as to not obliterate images displayed below the alphanumeric keypad. The gaming machine allows concurrent play of the game and generation of messages using the alphanumeric keypad.

The display may be controlled to display messages received via the communication interface and messages generated by the gaming machine over a game screen that presents the selected symbols, wherein the display of the alphanumeric keypad over the game screen allows all selected symbols to remain clearly visible to the player. The gaming machine may allow concurrent play of the game and display of messages received via the communication interface.

The generated message may be displayed on the display during generation together with a cursor indicating where new text for the message will be inserted, and the display may be controlled and the touch screen monitored to implement at least one editing control field that when operated causes a cursor to move around within a generated message.

The gaming machine may store a local dictionary for use in implementing the predictive text input technology, and operate to receive updates to the dictionary from a remote device.

According to a third aspect, the invention broadly resides in a gaming system including a plurality of gaming machines that each provide a game in which a plurality of symbols are selected and presented and if a winning combination occurs in the selected symbols, the gaming machine awards an award, and a server in communication with the plurality of gaming machines, wherein the gaming machines include an alphanumeric keypad and a display for use in generating messages and displaying messages received from other gaming machines respectively, and in response to operation of the alphanumeric keypad the gaming machine causes a message to be generated using predictive text input technology and sent to the server, wherein the server operates as a chat server, communicating messages received from one said gaming machine to a plurality of said gaming machines, and wherein those gaming machines display the communicated messages on their respective displays.

Another aspect of the present invention is a method of providing chat functionality on a gaming machine or a method of manufacturing a gaming machine to provide chat functionality, the method including providing an alphanumeric keypad on the gaming machine, operable by the player to enter inputs that are analysed using predictive text technology to form messages.

In still another aspect, the present invention relates to a game controller or a controller of peripheral device of a gaming machine, adapted to receive input commands from a hardware or software implemented alphanumeric keypad and generate messages for including in a chat session.

Further aspects of the present invention and further embodiments of the aspects described above will become apparent from the following description, given by way of example and with reference to the accompanying drawings.

### BRIEF DESCRIPTION OF THE DRAWINGS

FIG. 1: shows diagrammatically, a view of a gaming console suitable for implementing certain embodiments of the present invention.

FIG. 2: shows a block diagram of gaming machine suitable for implementing certain embodiments of the present invention.

FIG. 3: shows a block diagram of components of the memory of the gaming machine represented in FIG. 2.

FIG. 4: shows diagrammatically, a network gaming system suitable for implementing certain embodiments of the present invention.

FIG. 5: shows diagrammatically, a view of a player tracking module (PTM) according to one embodiment of the present invention.

FIG. 6: shows diagrammatically, a view of a screen display of a gaming console according to one embodiment of the present invention.

FIG. 7: shows diagrammatically, a view of a keypad and display according to one embodiment of the present invention.

FIG. 8: shows diagrammatically, a view of a chat presentation field according to one embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

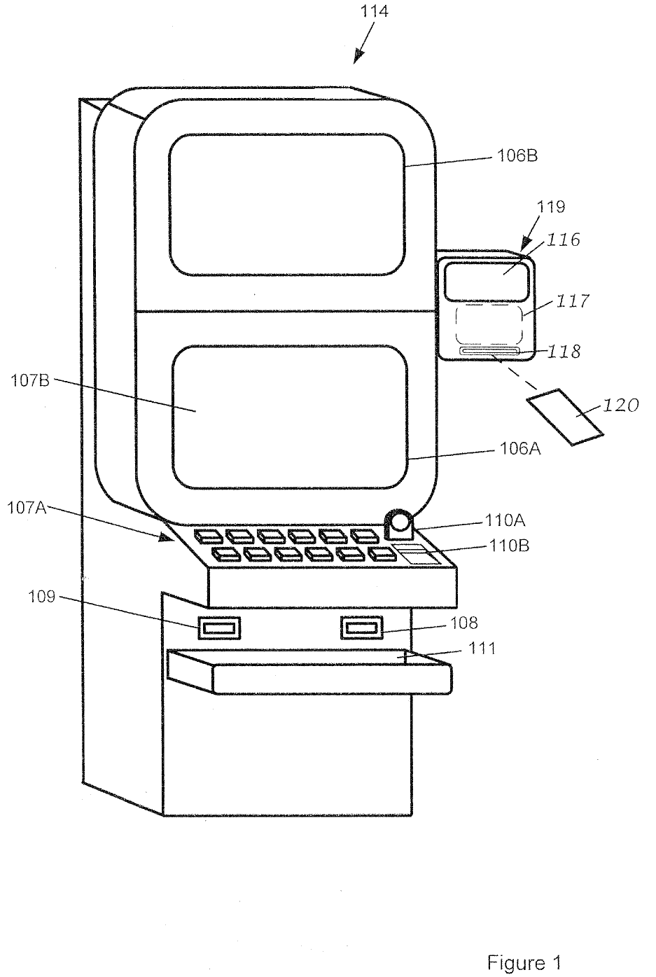

In FIG. 1 of the accompanying drawings, one example of a gaming console that is suitable to implement certain embodiments of the present invention is generally referenced by arrow 114.

The gaming console 114 includes two displays 106A, 106B on one or both of which is displayed representations of a game that can be played by a player and a bank of buttons 107A and/or a touch screen 107B to enable a player to play the game. The displays 106 may be video display units, such as a cathode ray tube screen device, a liquid crystal display, plasma screen, any other suitable video display unit, or the visible portion of an electromechanical device. The display 106B may display artwork, including for example, pay tables and details of bonus awards and other information or images relating to the game. In alternative gaming consoles the display 106B may be omitted, optionally replaced by a static display.

A credit input including a coin input 110A and/or bill collector 10B allows a player to provide credit for wagering and a coin output 111 is provided for cash payouts from the gaming console 114. A card and/or ticket reader 108 and a printer 109 may be provided to provide player tracking, cashless game play or other gaming and non-gaming related functions.

A player tracking module (PTM) 119 is attached to a side of the console 114. The PTM 119 includes an electronic display 116 and may also include a keypad 117, represented in outline in FIG. 1, and a card reader 118, which may also be a ticket reader or may be solely a ticket reader. The display 116 may, for example, be a LCD display or other video display or may be a LED display. As explained in more detail herein below, the card reader 118 may allow player identification through the insertion of a player card 120 including a machine readable player identifier. Typically only one of the readers 108, 118 are provided on a single gaming console to perform all card and ticket reading functions. The PTM may also be ‘virtual’, with PTM functionality integrated into the gaming application. In this configuration the PTM display 116 may be part of displays 106B and/or 107B.

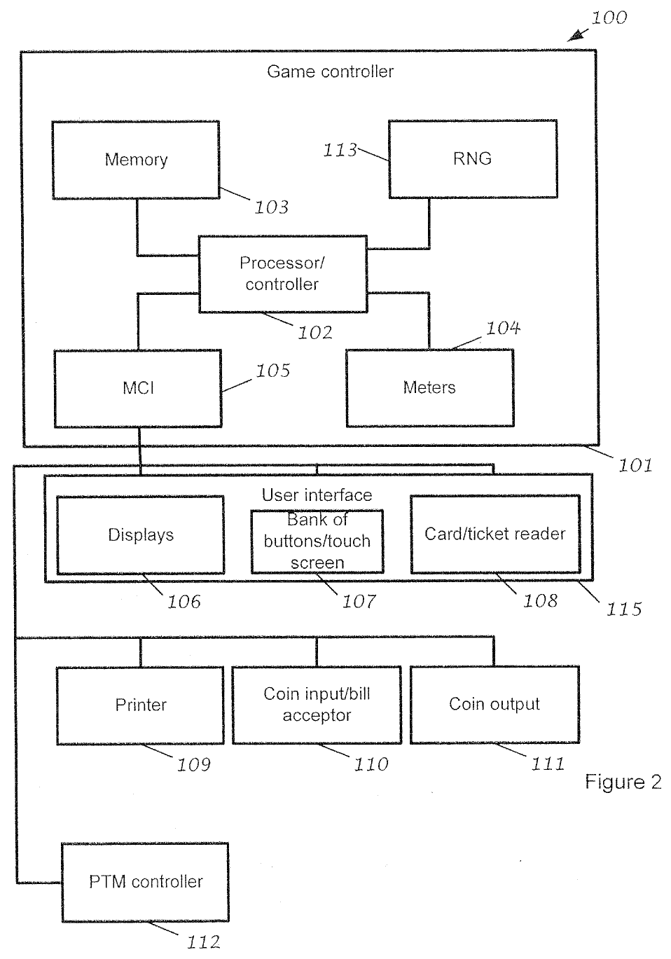

FIG. 2 shows a block diagram of a gaming machine, generally referenced by arrow 100, suitable for implementing certain embodiments of the present invention. The gaming machine 100 may include the gaming console 114 shown in FIG. 1 and accordingly like reference numerals have been used to describe like components in FIGS. 1 and 2.

The gaming machine 100 includes a game controller 101, which in the illustrated example includes a computational device 102, which may be a microprocessor, microcontroller, programmable logic device or other suitable device. Instructions and data to control operation of the computational device 102 are stored in a memory 103, which is in data communication with, or forms part of, the computational device 102. Typically, the gaming machine 100 will include both volatile and non-volatile memory and more than one of each type of memory, with such memories being collectively represented by the memory 103. The instructions to cause the game controller 101 to implement the present invention will be stored in the memory 103.

The game controller 101 may include hardware credit meters 104 for the purposes of regulatory compliance and an MCI 105 for communicating with the peripheral devices of the gaming machine 100 and for communicating with a network or other external communication channel. The MCI 105 may therefore include a network card allowing communication with an Ethernet. The MCI 105 and/or the peripheral devices may be intelligent devices with their own memory for instructions and data.

In the example shown in FIG. 2, the peripheral devices that communicate with the MCI 105 are the displays 106, bank of buttons/touch screen 107, the card and/or ticket reader 108, the printer 109, a bill acceptor and/or coin input 110, a coin output 111 and the PTM 119, which has its own PTM controller 112. Additional devices may be included as part of the gaming machine 100, or devices omitted as required for the specific implementation.

The bank of buttons 107A and/or touch screen 107B together with one or both of the displays 106 may provide a user interface 115 through which the gaming machine 100 and player communicate. If a card/ticket reader 108 is provided, this may also form part of the user interface 115.

The game controller 101 may also include a random number generator 113, which generates a series of random numbers that determine the outcome of a series of random game events played as part of a game on the gaming machine 100. The random number generator may be part of the standalone game controller or be separate, centrally located and connected to a plurality of game controllers.

The game controller 101 may have distributed hardware and software components that communicate with each other directly or through a network or other communication channel. In particular, the game controller 101 may be located in part or in its entirety remote from the user interface 115. Also, the computational device 102 may comprise a plurality of devices, which may be local or remote from each other.

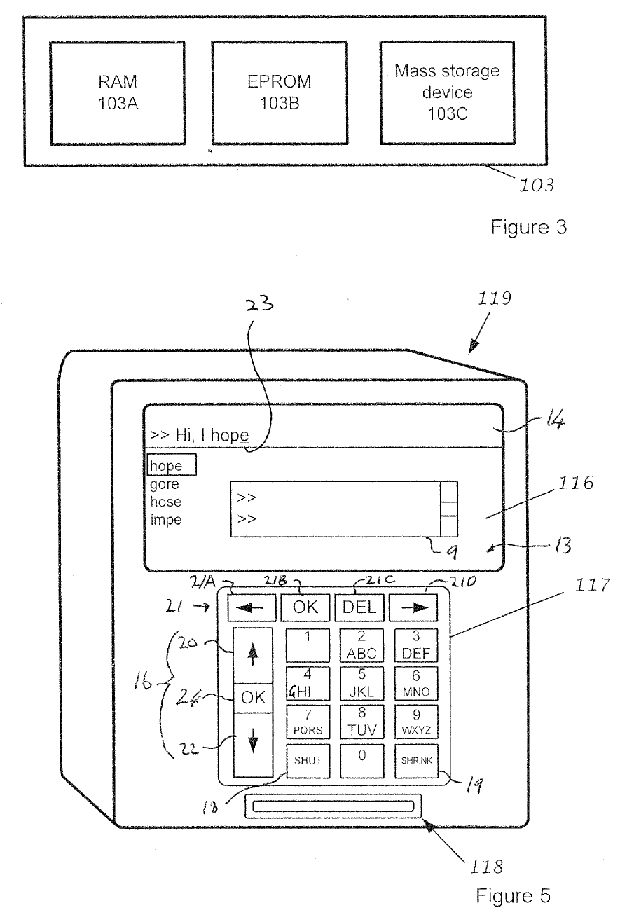

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game related code. The mass storage device 103C may be used to store game programs, the integrity of which may be verified and/or authenticated by the computational controller 102 using protected code from the EPROM 103B or elsewhere.

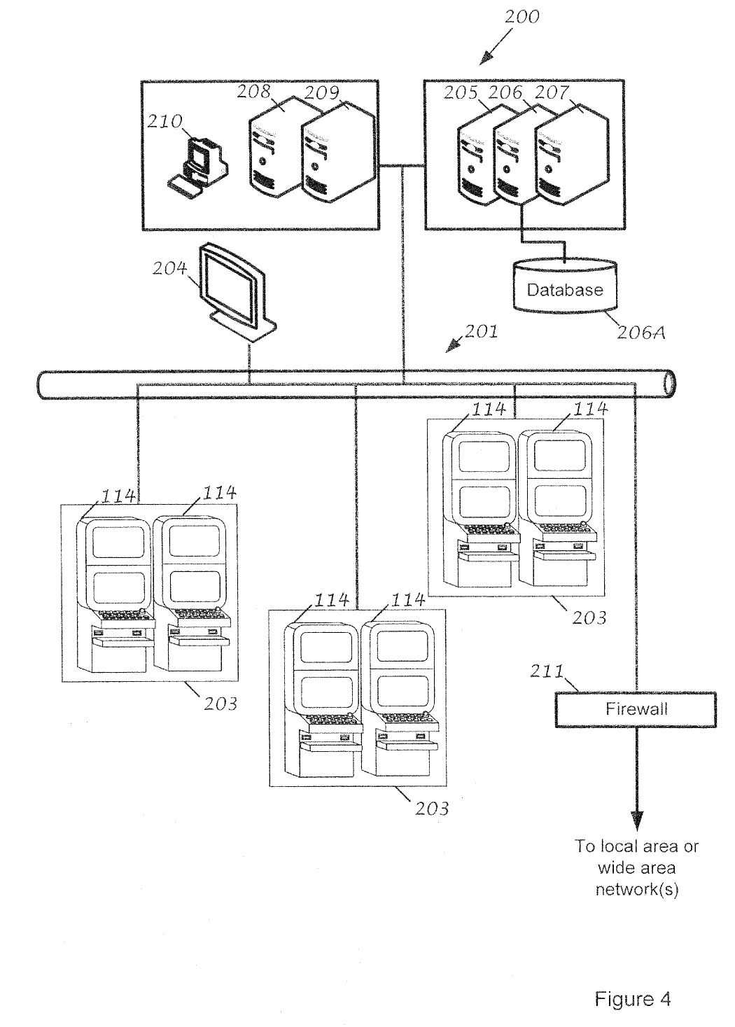

FIG. 4 shows a gaming system 200 in the form of a network of devices. The gaming system 200 includes a network infrastructure 201, which for example may be an Ethernet network. Alternatively, a wireless network and/or direct communication channels, or a different type of network may be used to link the gaming machines to a server, each other and/or other devices. Gaming consoles 114, shown arranged in three banks 203 of two gaming consoles 114 in FIG. 4, are connected to the network infrastructure 201. The gaming consoles 114 may form part or all of a gaming machine 100. Single gaming consoles 114 and banks 203 containing three or more gaming consoles 114 may also be connected to the network infrastructure 201, which may also include hubs, routers, bridges to other networks and other devices (not shown).

One or more displays 204 may also be connected to the network 201. The displays 204 may, for example, be associated with a bank 203 of gaming consoles 114. The displays 204 may be used to display representations associated with game play on the gaming consoles 114, and/or used to display other representations, for example promotional or informational material.

Servers 205-209 may also be connected to the network 201. The servers 205-209 may perform various functions, including generating game outcomes, managing the storage of game programs and associated data, controlling one or more jackpots, performing gaming floor management functions, and/or managing the licensing of games. The servers 205-209 may be able to control directly or indirectly the storage and retrieval of information from one or more databases 206A. An administrator terminal 210 may be provided to allow an administrator to manage the network 201 and the devices connected to the network.

The gaming system 200 may communicate with other gaming systems, other local networks, for example a corporate network and/or a wide area network such as the Internet through a firewall 211.

The foregoing description has been provided as an example of possible environments in which certain embodiments of the present invention may be implemented. However, those skilled in the relevant arts will appreciate that the invention is not necessarily limited to implementation in the environment described and that other suitable environments exist or may be developed.

FIG. 5 shows an enlarged view of the player tracking module (PTM) 119 according to one embodiment of the present invention, which includes a keypad 117, or the like. The keypad 117 includes a 4 by 3 matrix of 12 buttons that are marked similar to buttons on a typical mobile phone. The buttons therefore include the numerals 0-9, with numerals 2-9 having the letters a-z associated with them. In addition, the keypad 117 includes editing control fields 21, including a leftwards scroll field 21A, a select (ok) command field 21B, a delete (DEL) command field 21C and a rightwards scroll field 21D. These editing control fields 21 are used, inter alia, to control a cursor 23 in the sentence composition field 14 displayed on the electronic display 116. Also displayed on the display 116 is a word composition field 13.

The default position of the cursor 23 may be after the last input letter or word. The player can then navigate and select the position of the cursor 23 using the editing control fields 21.

The command control fields may further include a “shut” button 18 and a “shrink” button 19, allowing the sentence composition field 14 and the word composition field 13 to be closed or minimised as required, allowing other information to be displayed on the display 116. The keypad 117 may be used to input information related to other functions of the PTM 119 or the gaming machine 100, for example entering a PIN following insertion of the player tracking card 120. In addition or instead, further buttons or other interface devices may be provided on the PTM 119 to support other functions.

The gaming machine 100, which includes the PTM 119 and the PTM controller 112 (see FIG. 2), detects operation of the keypad 117 and uses a predictive text input technology, for example the T9™ text input technology available from Tegic Communications, Inc of Seattle, Wash., United States of America, to generate words for the message.

For example, if the player presses the combination of buttons ‘4’, ‘6’, ‘7’ and ‘3’ on the keypad 117, the gaming machine 100 may initially display in the word composition field 13 the set of four words ‘hope’, ‘gore’, ‘hose’, and ‘impe’. A player can then use a set of word selection control fields 16, which includes an upwards scroll field 20, a downwards scroll field 22 and a select (ok) field 24 to scroll up and down the words displayed in the word composition field 13 to select the word required for the message.

The words displayed in the word composition field 13 are extracted from a dictionary of words that may be formed from the letters displayed on the numbered buttons of the keypad 117. The dictionary also has a record of which word is most likely to be selected, based on known or learned usage patterns, and initially selects this word.

The electronic display 116 also displays a chat presentation field 9 that displays the messages generated by the player of the gaming machine 100 and messages received by the gaming machine 100 which have been generated by other gaming machines or other devices which are participating in the same chat session. The chat presentation field 9 is described in more detail herein below.

By utilising the player tracking module 119, chat functionality can be implemented on a gaming machine 100 independently of the play and display of games on one or both of the displays 106A, 106B. The PTM 119 may receive and communicate chat messages onto and from a network infrastructure 201 through the MCI 105 without using the game controller 102. Accordingly, the control of games played on the gaming machine 100 may be kept separate from the operation of a messaging or chat functionality at the gaming machine 100, which may have advantages in obtaining regulatory approval for new games without having to repeatedly check the software and/or firmware the provides the chat functionality.

The gaming system 200 includes a chat server 205, associated with a database 206A that contains the dictionary of words used for predictive text word generation. This dictionary is periodically distributed to the gaming machines 100, and stored in the gaming machines 100 and a required location in their respective memories 103, for example in the RAM 103A in the mass storage device 103C if provided, or in a memory of the PTM 119. The dictionary is maintained so as to be up-to-date and to reflect current language usage during chat sessions using the gaming system 200. Various steps can be taken to achieve this, including:

Adding to the dictionary words that are frequently used in the context of the gaming system 200. These words may include words that are frequently used in the context of a particular game, words that refer to the gaming venue or locations in the gaming venue, and others.

Creating a log file of words used in chat conversations. The chat server 205 may store words used in chat sessions for analysis. A frequency analysis may indicate words that are candidates for addition to the dictionary. Words that are determined to be used often but which are not present in the dictionary may then be added to the dictionary stored in the database 206A. Optionally, the chat server 205 may request approval from an administrator operating the administrator terminal 210 before adding words to the dictionary. This may avoid words that have been misspelt being included in the database or an inappropriate word being included. The chat server 205 may update the dictionary in the database 206A overnight, or during other periods when the chat functionality is not being utilised to capacity, ready for download to the gaming machine 100.

The dictionary may be downloaded or otherwise distributed to the gaming machines 100 each time the chat functionality is initialised, or on occurrence of another event, for example according to a time schedule.

In alternative implementations, particularly those using thin client consoles 114, the dictionary may be stored solely by the chat server 205 and the consoles 114 used only to provide an interface to players.

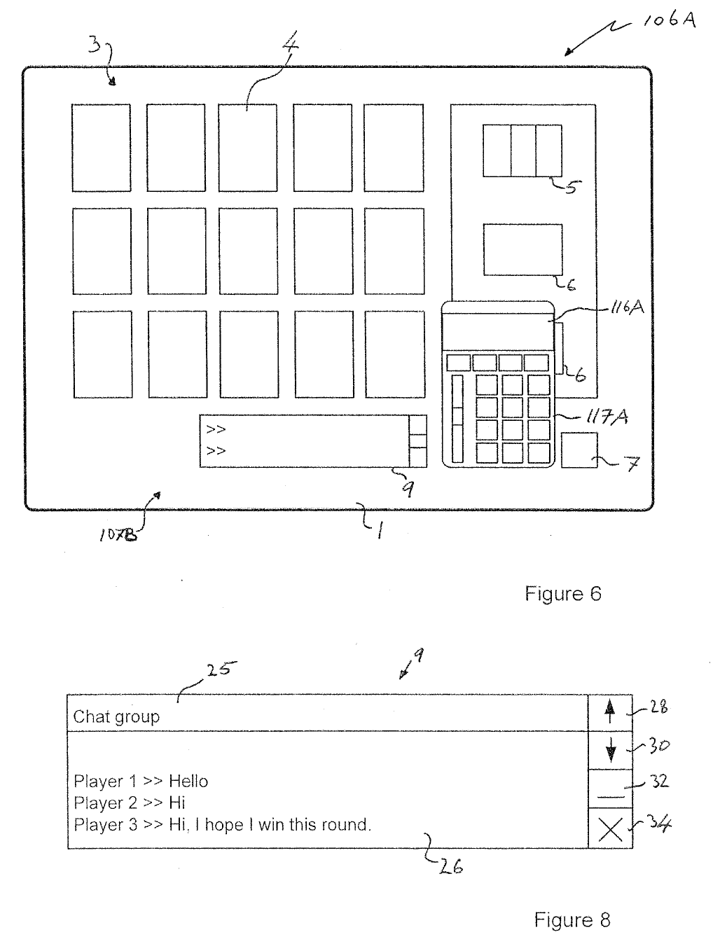

FIG. 6 shows a diagrammatic representation of a screen display 1 that may be displayed on the display 106A of a gaming console 114. The display 106A includes a touch screen 107B overlaying the display 106A. The screen display 1 includes game images 3, including symbols 4 (one only indicated by a reference numeral in FIG. 6), which in the example shown are arranged in a matrix of 3 rows and 5 columns. Control fields 5 and information fields 6 related to the game played on the gaming machine 100 may also be displayed. The display 1 also includes a chat interface icon 7 and a chat presentation field 9. Initially, the keypad 117A and display 116A and optionally also the chat presentation field 9 may not be displayed on the screen display 1. The player may select the interface icon 7 to cause these to be displayed. Accordingly, when a player does not wish to participate in a chat session, then there is no interference with the presentation of game information, other than the small chat interface icon 7. In other embodiments, the chat interface icon 7 may be omitted and a button or combination of buttons in the bank of buttons 107B or on the PTM 119.

The chat presentation field 9 is displayed in a location on the screen display 1 that does not cover or disturb the presentation of the game. The key pad 117A and display 116A may be displayed in front of a portion of the game representations 3. However, the keypad 117A and display 116A are not displayed so as to render the game symbols or not clearly visible. In one embodiment, the keypad 117A, display 116A and/or chat presentation field 9 may be displayed as a transparent or semi-transparent window, to allow game representations 3 to be viewed there through.

Although the presentation field 9 is shown in FIG. 6 as separate from the representations of the keypad 117A and display 116A, a single window may display all three fields. In addition, the player may be able to move the keypad 117A, display 166A and/or chat presentation field 9 about the screen display 1, for example, by pressing a finger on one of these fields and dragging it across the screen display 1.

The use of an alphanumeric keypad 117A allows a small amount of space to be used on the display 106A to present the interface for chat sessions. This may facilitate simultaneous play of a game and participation in a chat session, because the symbols 4 and other necessary information may remain visible. In addition, the minimal amount of space occupied by the keypad 117A allows artistic words, animations and other images, messages or information to be displayed, which may increase the attractiveness of the gaming machine 100 over if a large portion of the screen was used for the input device used for chat. Similarly, when a hardware keypad 117 is used, the space occupied by the input device is small, for example in comparison to a full sized keyboard.

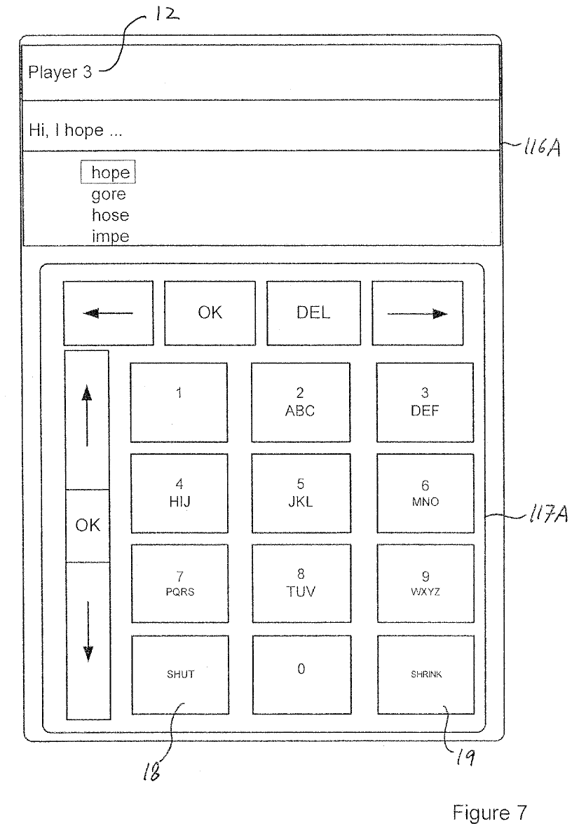

FIG. 7 shows an enlarged view of the keypad 117A and the display 116A. Both have fields that operate in the same way as the buttons described for the interface 117 and fields displayed on the display 116 described in relation to FIG. 5. In addition, a player identifier field 12 is displayed. This field may display a generic descriptor, for example the ‘Player 3’ descriptor that has been allocated to the player for the purposes of a chat session. Alternatively, the player may control what is displayed in the player identifier field 12, for example by entering a name or other identifier using the keypad 117A. Alternatively, the PTM 119 or gaming machine 100 may read a player identifier from a player tracking card 120 inserted into the card reader 118 of the PTM 119 and display this in the player identifier field 12. The player identifier is also displayed in the message presentation window 9 together with messages posted by that player (see FIG. 8).

In this embodiment, the “shut” button 18 may cause the keypad 117A and display 116A to not be displayed on screen display 1. The chat presentation field 9 may optionally still be displayed, either permanently, or until a separate close button 34 or shrink button 32 (see FIG. 8) is selected. The “shrink” button 19 may cause the chat functionality not to be displayed and able to be restored to show the same chat session by selecting the chat icon 7.

FIG. 8 shows an enlarged and more detailed view of a chat presentation field 9. This includes a chat group identification field 25 to identify which one of a number of possible chat groups that are being maintained by the chat server 205 is being displayed and a message field 26 that displays the chat conversation as it is generated by the gaming machines 100 and/or other devices participating in the chat session. When a player initiates a chat session, for example by selecting the chat icon 7, a list of current chat sessions may be displayed to the player who can then select which chat session they wish to join. An option may also be provided to create a new chat session. To facilitate the identification of a chat session, the player who creates the chat session may be requested to give the session a unique name using the keypad 117, 117A. A chat session may also be initiated by a player creating a chat session and inviting ‘known buddies’ to join the session. In this embodiment, a player is represented by a unique identity stored on a player card 120 which also stores a list of ‘known buddies’. Inserting the player card 120 into the PTM 119 established the player identity and the list of ‘known buddies’ may be extracted. The list may be displayed showing who is currently playing and connected to the communication network. A player may then create a chat session by selecting and querying one or more chat buddies to join the chat session. The player may also add or remove people from the ‘known buddies’ list by the operation of keypad 117.

The gaming venue operator may control the number of separate chat session that can be created, for example by preventing the creation of new chat sessions if a maximum number have been exceeded, or by setting up a fixed number of ‘chat rooms’, which the players can select to enter. The ‘chat rooms’ may be themed, focussed on different demographics or otherwise specified to encourage players fitting a certain description or players who want to chat to other players fitting a certain description to enter the appropriate room.

In certain embodiments, players may be given control over who is entitled to join a chat session. For example, a person who establishes a new chat session may specify the names of players that are entitled to join the chat session, for example by entering their names or another identifier associated with the player using the keypad 117, 117A. Alternatively, players may select a chat session to join, at which stage a message may be displayed at the machine where the chat session was first established requesting authorisation for that player to join. For example, a message: “Player X wishes to join your chat group A” may be displayed and two buttons could be displayed on the touch screen or directions to press particular buttons on the bank of buttons 107A to either authorise or reject the request to join the session. The name of the player may be automatically extracted from a player card 120 that has been inserted into the PTM 119, or another player identifier otherwise entered by the requesting player.

The chat presentation field 9 may include scroll buttons 28, 30 to allow upwards and downwards scrolling through the messages displayed in the message field 26. The shrink button 32 and the close button 34 are also displayed, which can be operated by a player of the gaming console 114 at will.

In some embodiments, the chat presentation field 9 may be displayed as part of the presentation of a game. For example, for multi-player games such a poker game, the chat presentation field 9, may be displayed as part of a representation of a poker table. The keypad 117A and display 116A may similarly be displayed on parts of the poker table. If a gaming tournament is entered by a group of players, then they may be automatically entered into a chat session that is dedicated to players in the tournament.

In one embodiment the dictionary may be only partially downloaded to the gaming machines. In this way, a type of caching arrangement may be set up, in which the most commonly entered words are downloaded to the gaming machines 100 and if numbers are entered that do not correspond to a word in the local dictionary, a request is sent to the chat server 205 to look up the appropriate database 206A, which contains the full dictionary.

In some embodiments, the keypad 117, 117A and display 116, 116A may be provided on the gaming console next to or as a part of the bank of buttons 107A. In still further alternatively embodiments, some information, for example the chat presentation field 9 may be displayed on the display 106B. Still further, if the gaming console 114 has an existing keypad, then that keypad may be used for implementing a chat function.

The presentation of the information in the chat presentation field 9 may be varied. In one embodiment, messages may be displayed in a ticketer, so as to scroll from right to left across the screen. Other variations are also possible.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A gaming machine that provides a game in which a plurality of symbols are selected and presented and if a winning combination occurs in the selected symbols, the gaming machine awards an award, the gaming machine comprising a communication interface for receiving and sending data to a remote device and an alphanumeric keypad, and in response to operation of the alphanumeric keypad the gaming machine causes a message to be generated using predictive text input technology, wherein the gaming machine is further arranged to send the generated message to the remote device over the communication interface, and wherein the gaming machine further includes a display that is controlled to display messages generated by and sent by the gaming machine and messages received by the gaming machine.

2. The gaming machine of claim 1 further comprising a player tracking module wherein said alphanumeric keypad is implemented as physical buttons provided on the player tracking module.

3. The gaming machine of claim 2 wherein said display is a display of said player tracking module.

4. The gaming machine of claim 2 wherein said player tracking module comprises a card interface.

5. The gaming machine of claim 4 wherein said card interface is a credit card reader.

6. The gaming machine of claim 1, wherein said display is controlled to display representations of said game and said alphanumeric keypad is implemented using images and a touch screen provided as part of said display.

7. A gaming machine that provides a game in which a plurality of symbols are selected and presented and if a winning combination occurs in the selected symbols, the gaming machine awards an award, the gaming machine comprising a communication interface for receiving and sending data to a remote device and a touch screen over a display, wherein the display is controlled to present an alphanumeric keypad and in response to operation of the touch screen over the alphanumeric keypad the gaming machine causes a message to be generated using predictive text input technology, wherein the gaming machine is further arranged to send the generated message to the remote device over the communication interface, and wherein the gaming machine further includes a display that is controlled to display the sent message and display messages received by the gaming machine from a remote device.

8. The gaming machine of claim 7 wherein the display is controlled to display the alphanumeric keypad after detecting a selection of an icon previously displayed on the display.

9. The gamine machine of claim 7 wherein the display is controlled to display the alphanumeric keypad over a game screen that presents the selected symbols, wherein the display of the alphanumeric keypad over the game screen allows all selected symbols to remain clearly visible to the player.

10. The gaming machine of claim 9 wherein the alphanumeric keypad is displayed transparently or semi-transparently so as to not obliterate images displayed below the alphanumeric keypad.

11. The gaming machine of claim 7 wherein the game machine allows concurrent play of the game and generation of messages using the alphanumeric keypad.

12. The gaming machine of claim 7 wherein the display is controlled to display messages received via the communication interface and messages generated by the gaming machine over a game screen that presents the selected symbols, wherein the display of the alphanumeric keypad over the game screen allows all selected symbols to remain clearly visible to the player.

13. The gaming machine of claim 12 wherein the game machine allows concurrent play of the game and display of messages received via the communication interface.

14. The gaming machine of claim 7 wherein the generated message is displayed on the display during generation together with a cursor indicating where new text for the message will be inserted,

15. The gaming machine of claim 14 further including at least one editing control field displayed on the display wherein in response to operation of the touch screen over the editing control field the cursor moves within the generated message.

16. The gaming machine of claim 1 wherein the gaming machine stores a local dictionary for use in implementing the predictive text input technology, and operates to receive updates to the dictionary from a remote device.

17. A gaming system comprising a plurality of gaming machines wherein each gaming machine provides a game in which a plurality of symbols are selected and presented and if a winning combination occurs in the selected symbols, the gaming machine awards an award, and a server in communication with the plurality of gaming machines, wherein the gaming machines include an alphanumeric keypad and a display for use in generating messages and displaying messages received from other gaming machines respectively, and in response to operation of the alphanumeric keypad the gaming machine causes a message to be generated using predictive text input technology and sent to the server, wherein the server operates as a chat server, communicating messages received from one said gaming machine to a plurality of said gaming machines, and wherein those gaming machines display the communicated messages on their respective displays.

18. A method of providing chat functionality on a gaming machine, including providing an alphanumeric keypad on the gaming machine, which is adapted to be operated by a player of the gaming machine to enter inputs, and analysing the inputs using predictive text technology to form messages.

19. A computer readable medium having a set of instructions for execution on a computing device having processing logic, said set of instructions comprising a keypad input routine accepting input from an alphanumeric keypad on a gaming machine and an analysis routine analysing the input from the keypad using predictive text technology to form messages to provide chat functionality on a gaming machine.
